(19) United States
(12) Patent Application Publication
(10) Pub. No.: US 2008/0178700 A1
(43) Pub. Date: Jul. 31, 2008

(54) THREE PAD PLASTIC SHIFTER FORK

(76) Inventors: Melinda Harmos, Windsor (CA); Tom Stepp, Lake Orion, MI (US); Hossam Khanafer, Windsor (CA)

Correspondence Address: HARNESS, DICKEY & PIERCE, P.L.C., P.O. BOX 828, BLOOMFIELD HILLS, MI, 48303, US

(21) Appl. No.: 12/023,526

(22) Filed: Jan. 31, 2008

Related U.S. Application Data
(60) Provisional application No. 60/898,537, filed on Jan. 31, 2007.

(51) Int. Cl. F16H 63/32

(52) U.S. Cl. 74/473.37

(57) ABSTRACT

A shift fork includes a body having a first branch terminating at a first free end and a second branch terminating at a second free end. A first pad is formed at the first free end. The second pad is formed at the second free end. A third pad is formed on the body at a position intermediate the first free ends. Each of the first, second and third pads includes a first surface aligned along a common plane.

### CROSS-REFERENCE TO RELATED APPLICATIONS

This application claims the benefit of U.S. Provisional Application No. 60/898,537, filed on Jan. 31, 2007. The disclosure of the above application is incorporated herein by reference.

### BACKGROUND AND SUMMARY

The present disclosure relates to a shift fork for a power transmission device.

Power transmission devices for automotive vehicles may be equipped with components arranged to provide at least two speed ranges. The power transmission devices, such as transfer cases, transmissions and the like, may include a shift fork to translate a synchronizer sleeve or clutch to cause the power transmission device to provide one of the two or more speed ranges. At least one known shift fork is constructed from an aluminum die casting which is subsequently machined to form a finished aluminum shift fork.

Known shift fork designs typically include two pads. One pad is formed at each free end of the fork. While machined aluminum shifter forks having two pads have functioned satisfactorily in the past, it may be desirable to provide a lower cost, lower weight shift fork for use with power transmission devices.

The shift fork of the present disclosure includes a one-piece shift fork having a forked body with branches spaced apart from one another where each branch terminates at a free end. A first pad is formed at one free end. A second pad is formed at the other free end. A third pad is formed on the body at a position intermediate the free ends. An axially protruding and circumferentially extending rib interconnects each of the three pads. Each pad includes a surface aligned along a common plane with the other pad surfaces. Based on the pad surface positioning in conjunction with the rib, stresses are evenly distributed during shift fork operation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic depicting an exemplary power transmission device equipped with a shift system including the shift fork of the present disclosure;

FIG. 2 is a perspective view of a shift fork of the present disclosure;

FIG. 3 is another perspective view of the shift fork depicted in FIG. 1;

FIG. 4 is a perspective view of another shift fork constructed according to the present disclosure;

FIG. 5 is another perspective view of the shift fork shown in FIG. 3;

FIG. 6 depicts various views of the shift fork shown in FIGS. 2 and 3; and

FIG. 7 depicts various views of the shift fork shown in FIGS. 4 and 5.

### DETAILED DESCRIPTION

The following description is merely exemplary in nature and is not intended to limit the present disclosure, application, or uses. It should be understood that throughout the drawings, corresponding reference numerals indicate like or corresponding parts and features.

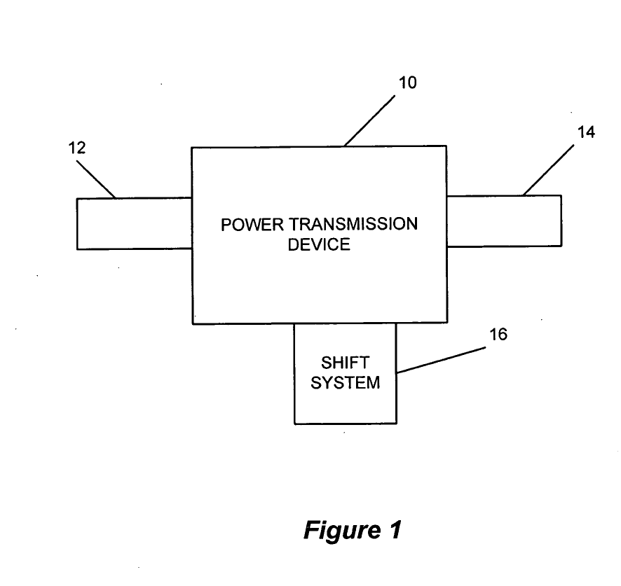

FIG. 1 depicts a power transmission device 10 drivingly interconnecting a first shaft 12 and a second shaft 14. Power transmission device 10 is operable to provide at least two speed ranges. In the first speed range, first shaft 12 rotates relative to second shaft 14 at a first ratio. The first speed range may include a ratio of 1:1 or virtually any speed ratio desired. When a second speed range of power transmission device 10 is provided, first shaft 12 rotates relative to second shaft 14 at a speed range other than the first speed range.

A shift system 16 is operable to selectively place power transmission device 10 in a first mode providing the first speed range or a second mode where power transmission device 10 provides the second speed range. Shift system 16 may be manually operated or automated to provide the desired speed ranges. Shift system 16 may include electric, hydraulic or electromagnetic actuators as desired.

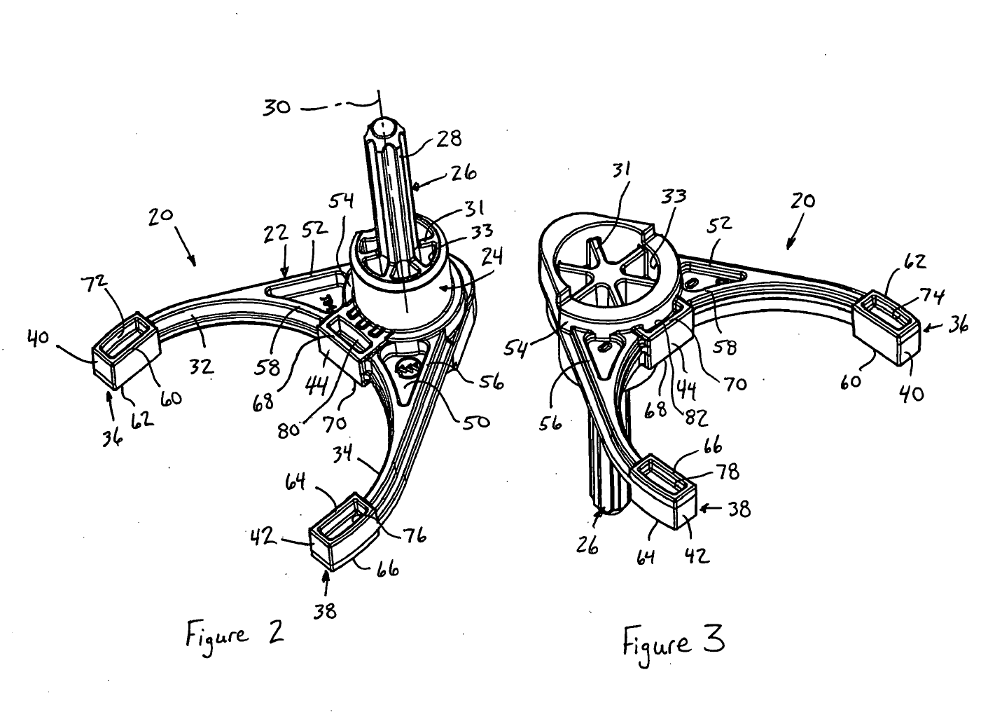

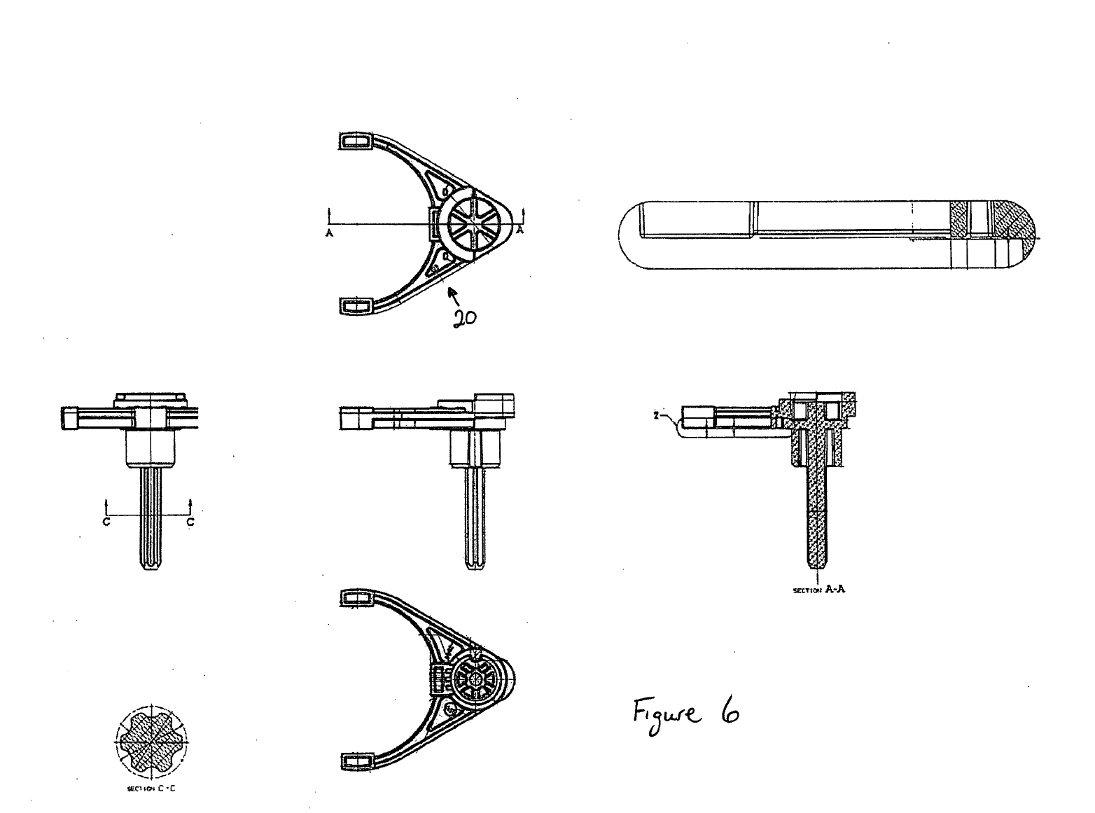

Shift system 16 includes an axially translatable shift fork 20 depicted in FIGS. 2, 3 and 6. Shift fork 20 is preferably injection molded from a high temperature nylon material such as Zytel® HTN material. In particular, it may be desirable to construct shift fork 20 from Zytel-HTN51G45 with 45% glass. It should be appreciated that shift fork 20 may alternatively be constructed from other materials.

Shift fork 20 includes a body 22 integrally formed with a hub portion 24. Hub portion 24 is a substantially hollow cylindrically-shaped member extending from body 22. A shaft 26 is integrally formed with hub portion 24 and body 22. A spline 28 is formed on an external surface of shaft 26. Shaft 26 and hub portion 24 are commonly aligned along an axis 30. Radially extending gussets 31 interconnect an inner surface 33 of hub portion 24 and an external surface of shaft 26.

Body 22 includes a first branch 32 and a second branch 34. First branch 32 includes a free end 36 while second branch 34 includes a free end 38. A first pad 40 is formed at free end 36. A second pad 42 is formed at free end 38. A third pad 44 is positioned intermediate first pad 40 and second pad 42 at a location where first branch 32 and second branch 34 interconnect.

Body 22 also includes a substantially planar web 50. A first rib 52 extends along an outer edge of web 50 and interconnects first pad 40 with a cylindrically shaped boss 54 axially extending from web 50. A second rib 56 extends along another outer surface of web 50 and interconnects second pad 42 with boss 54. A third rib 58 is arcuately shaped and interconnects first pad 40, third pad 44 and second pad 42. Third rib 58, as well as first and second ribs 52,56, function to enhance the stiffness of shift fork 20. First rib 52, second rib 56 and third rib 58 protrude from both surfaces of web 50.

First pad 40 includes a first contact surface 60 and an opposing second contact surface 62. Similarly, second pad 42 includes a first contact surface 64 and opposing second contact surface 66. Third pad 44 includes a first contact surface 68 and an opposing second contact surface 70. First contact surfaces 60, 64 and 68 are aligned along a common plane. Second contact surfaces 62, 66 and 70 are also aligned along a common plane. The planes previously discussed are positioned substantially parallel to one another. Furthermore, first contact surfaces 60, 64 and 68 axially extend above first rib 52, second rib 56 and third rib 58 such that the first contact surfaces 60, 64 and 68 of first, second and third pads 40, 42 and 44 contact a sleeve (not shown) of power transmission device 10 at substantially the same moment in time when a shift is desired. In this manner, forces act through each of first, second and third pads 40, 42 and 44 to distribute the stresses throughout shift fork 20. When shift fork 20 is moved in an opposite axial direction, second contact surfaces 62, 66 and 70 contact the shift sleeve at substantially the same moment in time to once again distribute the load throughout shift fork 20.

Upper and lower pockets 72,74 are formed on either side of first pad 40 to reduce the mass of shift fork 20. Similar pockets 76,78 are formed on second pad 42. Weight reduction pockets 80,82 are also formed on third pad 44.

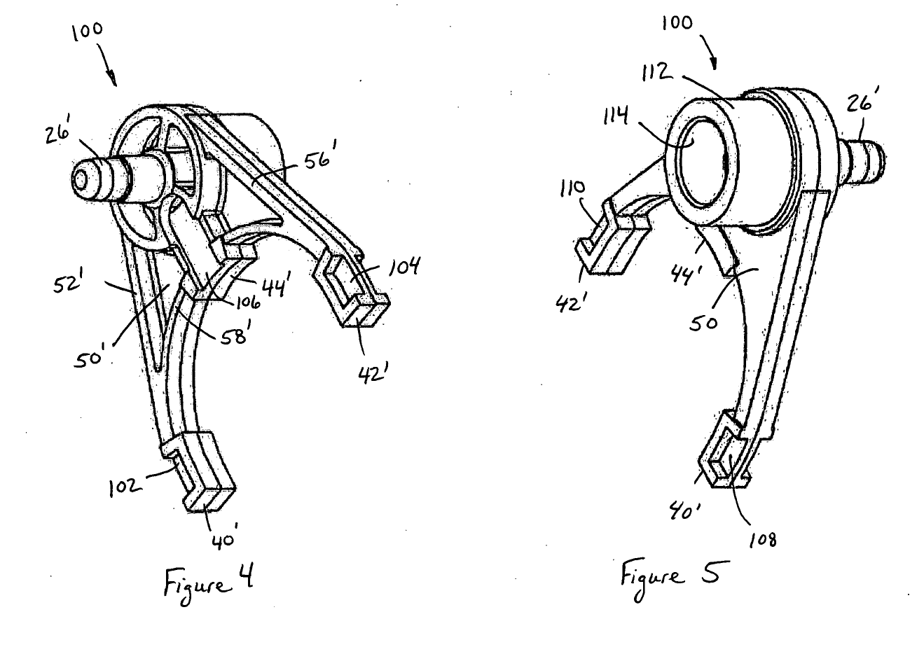

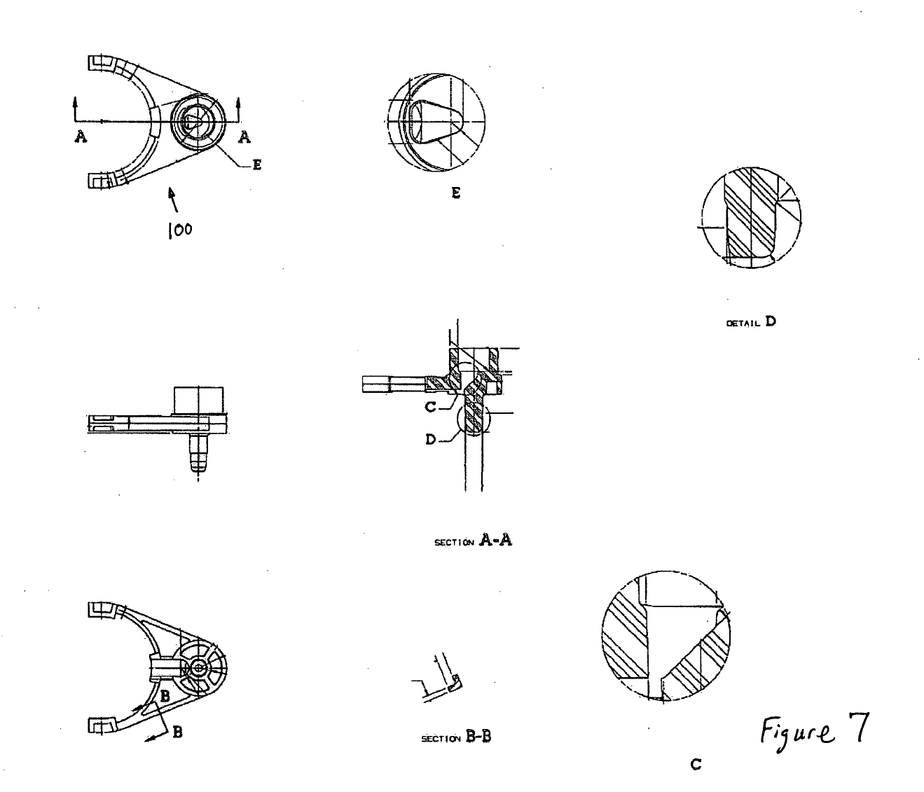

FIGS. 4, 5 and 7 depict another shift fork 100. Shift fork 100 is substantially similar to shift fork 20. Accordingly, only the major differences in the components will be described. Shift fork 100 includes first rib 52′, second rib 56′ and third rib 58′ extending from web 50′ in only one direction. As can be clearly seen from FIGS. 2 and 3, first, second and third ribs 52, 56 and 58 extend bi-directionally from web 50. Furthermore, shift fork 100 includes first, second and third pads 40′, 42′ and 44′ defined by substantially “C” shaped walls. The pads 40′, 42′, 44′ have open sided slots 102, 104 and 106 formed therein as opposed to the pockets 72, 76 and 80 previously described and shown in relation to FIG. 2. Additional slots 108 and 110 are formed on the opposite side of first pad 40′ and second pad 42′. A substantially hollow cylindrical hub 112 axially extends from web 50′ in a direction opposite shaft 26′. An inner cylindrical surface 114 of hub 112 is sized to mate with a component (not shown) of power transmission device 10 to support shift fork 100 thereon. Shift fork 100 is axially moveable relative to the component to selectively place power transmission device 10 in one of the first or second modes to provide the first speed range or the second speed range.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A shift fork comprising:
a body having a first branch terminating at a first free end and a second branch terminating at a second free end;
a first pad formed at the first free end;
a second pad formed at the second free end; and
a third pad formed on the body at a position intermediate the free ends, wherein each of the first, second and third pads includes a first surface aligned along a common plane.

2. The shift fork of claim 1 further including an axially protruding rib interconnecting the first, second and third pads.

3. The shift fork of claim 2 further including a hub integrally formed with and axially extending from the body.

4. The shift fork of claim 3 further including a shaft integrally formed with and axially extending from the hub.

5. The shift fork of claim 4 wherein the shaft includes an external spline.

6. The shift fork of claim 1 wherein the first, second and third pads each include a second surface opposite the first surface aligned along a plane extending parallel to the plane containing the first surfaces of the first, second and third pads.

7. The shift fork of claim 6 wherein the first and second pads include pockets encompassed by side walls at least partially defined by the first surface of the first and second pads.

8. The shift fork of claim 1 wherein the body includes a boss and a substantially planar web interconnecting the first branch with the boss.

9. The shift fork of claim 1 wherein the shift fork is molded from a high temperature nylon having forty-five percent glass content.

10. The shift fork of claim 1 wherein the body includes a radially extending web, the rib axially extending bi-directionally from the web.

11. The shift fork of claim 1 further including a first rib interconnecting the first and third pads as well as a second rib interconnecting the second and third pads.

12. The shift fork of claim 1 wherein the body includes a boss portion, the shift fork further including a third rib interconnecting the first pad and the boss as well as a fourth rib interconnecting the second pad and the boss.

13. A shift fork comprising:
a body having a first branch terminating at a first free end, a second branch terminating at a second free end and a web interconnecting the first and second branches;
a first pad formed at the first free end;
a second pad formed at the second free end; and
a third pad formed on the body at a position intermediate the first and second free ends, wherein each of the first, second and third pads includes a first surface aligned along a common plane.

14. The shift fork of claim 13 further including a first rib axially protruding from the web and interconnecting the first and third pads.

15. The shift fork of claim 14 further including a second rib axially protruding from the web and interconnecting the second and third pads.

16. The shift fork of claim 15 further including a hub integrally formed with and axially extending from the body.

17. The shift fork of claim 16 further including a shaft integrally formed with the body and axially extending therefrom in an opposite direction as the hub.

18. The shift fork of claim 13 wherein the first, second and third pads are adapted to contact a power transmission device to vary an operating mode of the device.

19. The shift fork of claim 13 wherein the first and second pads are defined by substantially “C”-shaped walls.

20. The shift fork of claim 13 wherein the shift fork is molded from a high temperature nylon having forty-five percent glass content.
